(19) United States
(12) Patent Application Publication
(10) Pub. No.: US 2007/0051182 A1
(43) Pub. Date: Mar. 8, 2007

(54) Mechanical quantity sensor

(76) Inventors: Akira Egawa, Chiba-shi (JP); Mitsuo Yarita, Chiba-shi (JP); Takeshi Uchiyama, Chiba-shi (JP)

Correspondence Address: BRUCE L. ADAMS, ESQ., SUITE 1231, 17 BATTERY PLACE, NEW YORK, NY, 10004, US

(21) Appl. No.: 11/515,649

(22) Filed: Sep. 5, 2006

(30) Foreign Application Priority Data
Sep. 6, 2005 (JP) 2005-258040
Aug. 4, 2006 (JP) 2006-213267

(51) Int. Cl. G01B 7/16

(52) U.S. Cl. 73/777

(57) ABSTRACT

Detection accuracy of a sensor is improved by reducing an influence of an exogenous noise. Acceleration acting on an object is detected based on a change of posture of a mass part supported by a flexible substrate. The flexible substrate is fixed at a frame and the mass part is fixed by soldering at the center thereof. When a force such as acceleration acts on the mass part, the posture of the mass part changes and the flexible substrate also becomes deformed. The change of posture of the mass part and the deformation of the flexible substrate are detected based on the amount of change of a circuit constant of a piezoresistive element as a detecting element provided at a beam part. A signal processing circuit for processing a signal detected by the detecting element is formed on an IC chip, by which the mass part is configured. Configuration of the mass part by the IC chip makes, it possible to configure so that a distance between the signal processing circuit and the detecting element can be short and to reduce an influence of an exogenous noise.

### BACKGROUND OF THE INVENTION

1. Field of the Invention

The present invention relates to a mechanical quantity sensor for detecting a mechanical quantity such as acceleration and angular velocity.

2. Related Art

Various mechanical quantity sensors are used in many fields including camera-shake correcting device in a video camera, in-car airbag, attitude control device for robot and so on.

There is a mechanical quantity sensor detecting acceleration and angular velocity acting on an object as disclosed in the following Patent Documents.

Patent Document 1: JP-A-4-81630

Patent Document 2: JP-A-7-43226

Patent Document 3: JP-A-11-101697

In the Patent Documents 1 and 2, a sensor for measuring the acceleration acting on a mass part supported by a flexible part by detecting a mechanical deformation of the flexible part are disclosed.

In order to detect the mechanical deformation of the flexible part, in more detail, there is disclosed a method using a change of electrical resistance of a piezoresistive element formed on the flexible part in a predetermined direction in the Patent Document 1 while there is disclosed a method using a change of voltage (electric charge) due to a piezoelectric effect of a piezoelectric element formed at the flexible part in the Patent Document 2.

In the Patent Document 3, a device for measuring the acceleration acting on a movable part by detecting an inclination of the movable part supported by the flexible part is disclosed.

In more detail, the inclination of the movable part is calculated based on the difference of the capacitances between two pairs of counter electrodes respectively provided in two directions of x-axis and y-axis.

Note that the calculation of the movable part is performed based on a value of an electrical signal (voltage signal) into which the capacitance between the counter electrodes is converted by using a C/V converter circuit.

Also in the Patent Document 3, a device for measuring the angular velocity acting on the movable part by providing an electrode for driving for oscillating the movable part at a predetermined frequency in a z-axis direction is disclosed.

In more detail, Coriolis force is generated with the action of the angular velocity around x-axis or y-axis in a state where the movable part is oscillated in z-axis direction. The angular velocity can be measured by calculating the inclination of the movable part with the action of the Coriolis force, based on the difference of the capacitance between the counter electrodes.

In a mechanical quantity sensor for detecting acceleration and angular velocity based on the change of posture of the mass part (movable part), a sensor part (detecting element) for detecting the change of posture of the mass part (movable part) as an electrical signal and a signal processing part (detecting means) for processing the detected electrical signal are formed independently. In addition, there are wired so as for a detection signal in the sensor part to be input to the signal processing part.

The detection accuracy of the mechanical quantity sensor may deteriorate with an influence of a disturbance noise such as radio noise. Especially in the case where the signal before processed in the signal processing part, i.e., the detection signal in the sensor part receives an exogenous noise, the influence thereof becomes obvious in a sensor output.

In a conventional mechanical quantity sensor, since the signal processing part is provided outside the frame, a connection line between the sensor and the signal processing part is wired so that the detection signal in the sensor part is drawn to an external signal processing part.

The connection line for drawing a signal before processed in the signal processing part (detecting means) is easily affected by a noise due to an increase of parasitic capacitance with its long wiring length. For this reason, when the sensor part (detecting element) and the signal processing part (detecting means) are arranged apart from each other, the detection accuracy of sensor may deteriorate.

### SUMMARY OF THE INVENTION

Therefore, the invention aims at providing a mechanical quantity sensor for improving the detection accuracy by reducing the influence of noise received by the signal input to the detecting means.

According to a first aspect of the invention, the above object can be achieved by comprising: a frame; a movable part including a flexible part fixed at the frame and a mass part which is supported by the flexible part and whose posture changes with an action of an external force; a detecting element at least apart of which is provided at the movable part; a detecting means provided at the movable part and for detecting the change of posture of the mass part based on a change of a circuit constant of the detecting element; and a converting means for converting the change of posture of the mass part detected by the detecting means into a mechanical quantity.

According to a second aspect of the invention, in the first aspect of the invention, the detecting means is formed at the mass part.

According to a third aspect of the invention, in the first or second aspect of the inventions the detecting element includes a piezoresistive element provided at the flexible part.

According to a fourth aspect of the invention, in the first or second aspect of the invention, the detecting element includes a capacitive element in which an electrode on one side is provided at the movable part.

According to a fifth aspect of the invention, in the first or second aspect of the invention, the detecting element includes a piezoelectric element provided at the flexible part.

According to a sixth aspect of the invention, in any of the first to fifth aspects of the invention, the mass part includes a semiconductor chip with at least the detecting means formed.

According to a seventh aspect of the invention, in the sixth aspect of the invention, the semiconductor chip and the flexible part are provided with a fixed pad pairing each other and are bonded to each other by flip chip bonding or wire bonding through the fixed pad.

According to an eighth aspect of the invention, in the seventh aspect of the invention, the fixed pad is provided at a position where a mass is distributed so as to keep a mass balance of the mass part.

According to the first aspect of the invention, the provision of the detecting means in the movable part makes the wiring connecting the detecting element and the detecting means short. Thereby the exogenous noise received through the connection wiring is reduced to improve sensor accuracy.

According to the second aspect of the invention, formation of the detecting means at the mass part can make the sensor small easily.

According to the third, fourth or fifth aspect of the invention, configuring the detecting element by the piezoresistive element the capacitive element or the piezoelectric element makes it possible to detect the change of posture of the mass part by using a configuration with high versatility and inexpensive price.

According to the sixth aspect of the invention, configuring the mass part by the semiconductor chip with the detecting means formed makes it possible to secure the mass of the movable part even in the case of the downsized sensor, to limit the deterioration of sensor sensitivity.

According to the seventh aspect of the invention, provision of the fixed pad at the semiconductor chip and the flexible part and bonding by flip chip bonding or wire bonding through the fixed pad make it possible to bond the semiconductor chip and the flexible part electrically adequately.

According to the eighth aspect of the invention, provision of the fixed pad at the position where the mass is distributed so as to keep the mass balance of the mass part makes it possible to keep the mass balance adequately to limit the occurrence of failure due to crosstalk.

### BRIEF DESCRIPTION OF THE DRAWINGS

FIG. 1 is a sectional view showing a schematic configuration of an acceleration-sensor according to the first embodiment.

FIG. 2 is a plan-view of a flexible substrate of the acceleration sensor seen from below.

FIG. 3 is a sectional view showing a schematic configuration of an angular velocity sensor according to the second embodiment.

FIG. 4A is a plan view of a flexible substrate of the angular velocity sensor seen from above, and FIG. 4B is a plan view of the flexible substrate seen from below.

FIG. 5 is a plan view of a fixed substrate of the angular velocity sensor according to the second embodiment seen from below.

FIG. 6 is a sectional view showing a schematic configuration of an acceleration sensor according to the third embodiment.

FIG. 7A is a plan view of a flexible substrate of the acceleration sensor seen from below, and FIG. 7B is a plan view of the flexible substrate seen from above.

### DESCRIPTION OF PREFERRED EMBODIMENTS

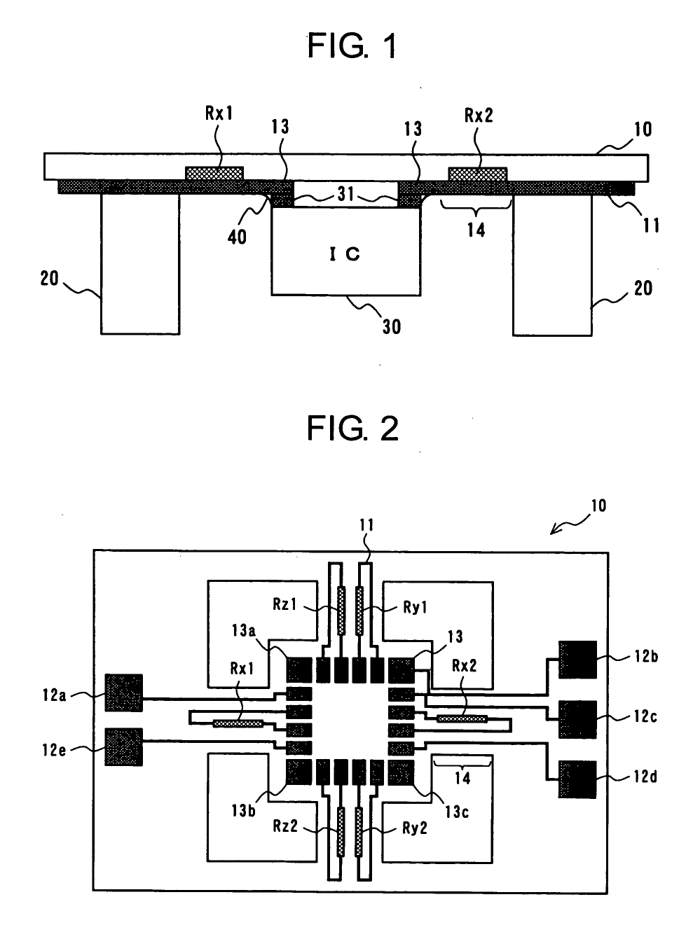

Hereafter, an embodiment of the invention will be described in reference to FIGS. 1 to 4.

### (1) Summary of Embodiment

A mechanical quantity such as acceleration and angular velocity acting on an object is detected based on the change of posture of a mass part (mass body) supported by a flexible member.

The flexible member is configured by a member such as thin silicon substrate that can be easily subject to deformation (deflection, warpage, bending). In addition, the flexible member is fixed at a frame and the mass part (mass body) is fixed at the center thereof.

With the action of force such as acceleration on the mass part, the posture of the mass part changes and the flexible member also deforms with this.

A signal processing circuit (detecting means) detects the change of posture of the mass part and the deformation of the flexible member based on an amount of change of characteristics such as an amount of change of a circuit constant in a detecting element provided at a movable part. As the detecting element, a piezoresistive element and a capacitive e element are used.

In the mechanical quantity sensor according to this embodiment, the signal processing circuit for processing the signal detected by the detecting element is formed on an IC chip, by which the mass part is configured.

As described above, configuration of the mass part by the IC chip with the signal processing circuit formed can shorten the distance between the signal processing circuit and the detecting element.

Therefore, since the wiring between the signal processing circuit and the detecting element can be configured to be short, the parasitic inductance and the parasitic capacitance (floating capacitance) of this wiring can be made small.

Also, reduction of the parasitic inductance and the parasitic capacitance (floating capacitance) can reduce the influence of an exogenous noise received by a sensor to improve the sensor sensitivity and accuracy.

Further, according to this embodiment, configuration of the signal processing circuit as the IC chip to function as the mass part can omit the formation region of the signal processing circuit conventionally provided outside a sensor structure and configured by the movable part and the detecting element, to downsize adequately.

### (2) Details of Embodiment

In this embodiment, an acceleration sensor and an angular velocity sensor will be described as an example of the mechanical quantity sensor.

Also, the mechanical quantity sensor according to this embodiment is configured by using a semiconductor sensor element formed by processing a semiconductor substrate. Note that the semiconductor substrate can be processed by MEMS (microelectromechanical system).

The direction orthogonal to the layout surface of a substrate configuring the sensor is defined as vertical direction, i.e., z-axis (direction). The axes orthogonal to this z-axis and orthogonal to each axis are defined as x-axis (direction) and y-axis (direction). In other words, x-axis, y-axis and z-axis are three axes orthogonal to each other.

### First Embodiment

In the first embodiment, there will be described an acceleration sensor using a piezoresistive element as a detecting element.

FIG. 1 is a sectional view showing a schematic configuration of the acceleration sensor according to the first embodiment.

Also, FIG. 2 is a plan view of a flexible substrate 10 of the acceleration sensor shown in FIG. 1 seen from below.

As shown in FIG. 1, the acceleration sensor is provided with the flexible substrate 10, a frame 20 and a mass part 30.

The flexible substrate 10 is formed by a substrate with flexibility (for example, a silicon substrate).

In the flexible substrate 10, as shown in FIG. 2, a beam part 14 is formed by L-shape etching at four places around the position where the mass part 30 is provided.

The beam part 14 is a part having belt-like flexibility extending radially (in the direction of the frame 20) in a cross direction from the center of the mass part 30. The mass part 30 is supported in a movable state by four beam parts 14.

In the beam part 14, in addition, piezoresistances Rx1, Rx2, Ry1, Ry2, Rz1 and Rz2 as a detecting element for detecting the deformation of the beam part 14 itself are formed in a predetermined direction.

In addition, when the flexible substrate 10 is configured by a silicon substrate, these piezoresistances Rx1, Rx2, Ry1, Ry2, Rz1 and Rz2 can be directly created by performing a processing such as ion implantation on the flexible substrate 10.

The frame 20 is a fixed part configured by a hollow prismatic member provided at the periphery to surround the mass part 30 and configures the frame of the acceleration sensor.

The mass part 30 is a mass body fixed at the frame 20 through the four beam parts 14 of the flexible substrate 10. The mass part 30 can oscillate and twist with the force from the outside, with the action of the beam part 14.

The mass part 30 is formed by an IC chip with the formation of the signal processing circuit for processing electrically the detection signal detected by the detecting element.

In this embodiment, in addition, the part between the IC chip configuring the mass part 30 and the flexible substrate 10, that is, a mass joint 40 is fixed by soldering plural IC connection pads 13 formed on the flexible substrate 10 and a pad 31 provided on the IC chip side by using FCB (flip chip bonding), etc.

As shown in FIG. 2, the above-described piezoresistances Rx1 and Rx2, Ry1 and Ry2, Rz1 and Rz2 are provided on the contraposing beam part 14 to pair each other.

With the acceleration on the acceleration sensor, an external force acts on the mass part 30. Thereby the beam part 14 supporting the mass part 30 becomes subject to mechanical deformation.

With the mechanical deformation on the beam part 14, the resistance values of the piezoresistances Rx1, Rx2, Ry1, Ry2, Rz1 and Rz2 change.

The mechanical deformation of the beam part 14 is detected based on the change of the resistance values of the piezoresistances in each axis direction, and the external force acting on the mass part 30, i.e., the acceleration attained on the acceleration sensor is measured based on this detection result.

The x-axis direction component of the external force acting on the mass part 30 is calculated based on the change of the resistance values of the piezoresistances Rx1 and Rx2. Similarly, the y-axis direction component of the external force acting on the mass part 30 is calculated based on the change of the resistance values of the piezoresistances-Ry1 and Ry2 while the z-axis direction component of the external force acting on the mass part 30 is calculated based on the change of the resistance values of the piezoresistances Rz1 and Rz2.

In addition, each axis direction component of the external force acting on the mass part 30 is output as a processing result in the signal processing circuit formed on the IC chip configuring the mass part 30.

In the IC connection pad 13, each piezoresistance Rx1, Rx2, Ry1, Ry1, Rz1 and Rz2 is electrically connected through a wiring pattern 11.

By bonding the pad 31 provided on the IC chip side to the IC connection pad 13 through a solder bump, etc., the piezoresistances Rx1, Rx2, Ry1, Ry2, Rz1 and Rz2 can be electrically connected to the signal processing circuit.

In addition, the flexible substrate 10 is provided with external discharge pads 12a-e near the outer edge thereof.

The external discharge pads 12a-e are also electrically connected to the IC connection pad 13 through the wiring pattern 11.

The external discharge pad 12a is a power input terminal for applying operating voltage of the detecting circuit configured by the piezoresistances Rx1, Rx2, Ry1, Ry2, Rz1 and Rz2 and the signal processing circuit formed on the IC chip from the outside.

The external discharge pad 12b is an output terminal of the x-axis direction component of the external force acting on the mass part 30, that is, the x-axis direction component of acceleration output as a processing result in the signal processing circuit formed on the IC chip.

The external discharge pad 12c is an output terminal of the y-axis direction component of the external force acting on the mass part 30, that is, the y-axis direction component of acceleration output as a processing result in the signal processing circuit formed on the IC chip.

The external discharge pad 12d is an output terminal of the z-axis direction component of the external force acting on the mass part 30, that is, the z-axis direction component of acceleration output as a processing result in the signal processing circuit formed on the IC chip.

The external discharge pad 12e is connected to a ground (GND) in the signal processing circuit formed on the IC chip. The external discharge pad 12e is connected to a frame ground (FG) in the acceleration sensor.

In a triaxial acceleration sensor thus configured, the change of posture of the mass part 30 changing corresponding to the action of the acceleration applied from the outside is detected based on the change of the resistance values of the piezoresistances Rx1, Rx2, Ry1, Ry2, Rz1 and Rz2.

Then there is performed a process for calculating (detecting) the amount of change of posture of the mass part 30, i.e., displacement for each direction component, based on the amount of change of the detected resistance values, in the signal processing circuit of the IC chip.

And then the signal processing circuit calculates the acceleration based on the amount of the change of posture of the mass part 30 calculated (detected).

The result of processing in the IC chip is output to the outside from the external discharge pads 12b-d as a mechanical quantity signal (here, an acceleration signal).

Note that in this embodiment the signal processing circuit functions as detecting means or converting means.

According to the first embodiment, provision of the signal processing circuit, i.e., IC chip near the piezoresistances Rx1, Rx2, Ry1, Ry2, Rz1 and Rz2 as displacement detecting means (detecting element) of the mass part 30 can shorten the wiring connecting the detecting element to the signal processing circuit.

With this, the influence of the disturbance noise received through the wiring connecting the detecting element to the signal processing circuit can be reduced, so that the sensor sensitivity and accuracy can be improved more.

Also, configuring the mass part 30 by the IC chip with the signal processing part formed can downsize the acceleration sensor without changing the shape of the mass part 30 greatly.

As described above, since there can be configured in the sensor part without changing the shape of the mass part 30, that is, without reducing the mass of the movable part, deteriorations of sensor sensitivity and accuracy with downsizing is not caused.

In the acceleration sensor according to the first embodiment, although the flexible substrate 10 and the frame 20 are formed separately, the flexible substrate 10 and the frame 20 can be formed integrally in the case of forming the flexible substrate 10 by silicon (Si) substrate.

In the case of forming the flexible substrate 10 and the frame 20 integrally, there is used, for example, D-RIE (deep-reactive ion etching) technology performing deep trench etching by plasma.

D-RIE is anisotropic etching as a kind of dry etching in which etching proceeds in a predetermined direction.

Note that, in an etching process, silicon oxide, silicon nitride and resist are used as a mask material for etching.

Other than D-RIE, dry etching process such as reactive ion etching and inductively-coupled plasma etching may be used.

In the acceleration sensor according to the first embodiment, although the flexible substrate 10 and the IC chip (mass part 30) are fixed (connected) to each other by soldering using FCB, the method of fixing the IC chip is hot limited to this.

The flexible substrate 10 and the IC chip may be electrically connected by using, for example, W/B (wire/bonding). It should be noted that in the case of wiring using W/B the IC chip is fixed in advance by adhesive, etc. to the flexible substrate 10.

In the acceleration sensor according to the first embodiment, although the mass part 30 is supported through four beam parts 14, the method of supporting the mass part 30 is not limited to this.

For example, when the flexible substrate 10 is configured by a member flexible enough to support the mass part 30 in a movable state, a diaphragm structure without providing the beam part 14 may be used.

Further in the acceleration sensor according to the first embodiment, although components of three axes, x-axis, y-axis and z-axis can be detected (measured), the acceleration sensor is not limited to such a three-axis sensor. For example, there may be applied a single-axis sensor for detecting only acceleration working on only an x-axis direction or a two-axis sensor for detecting acceleration working on x-axis and y-axis directions.

In the acceleration sensor according to the first embodiment, there are provided dummy pads 13a-c which are not electrically connected to the piezoresistances Rx1, Rx2, Ry1, Ry2, Rz1 and Rz2 as a detecting element, the external discharge pads 12a-e, the signal processing circuit and so on.

Provision of such dummy pads 13a-c can improve fixing strength of the IC chip (mass part 30).

Also, provision of such dummy pads 13a-c makes it possible to arrange the pad (electrode) symmetrically to keep the mass balance of the mass part 30 (IC chip) adequately.

As described above, supporting the mass part 30 keeping the mass balance adequately can avoid an error due to sensitivity to other axes in detecting x-axis or y-axis, that is, crosstalk.

### Second Embodiment

Next, an angular velocity sensor (gyro sensor) will be described as the preferred second embodiment of the invention.

In the second embodiment, there will be described an angular velocity sensor using a capacitive element as a detecting element.

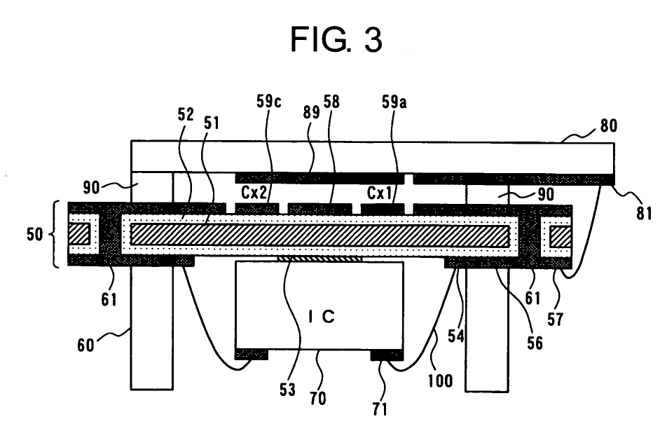

FIG. 3 is a sectional view showing a schematic structure of the angular velocity sensor according to the second embodiment.

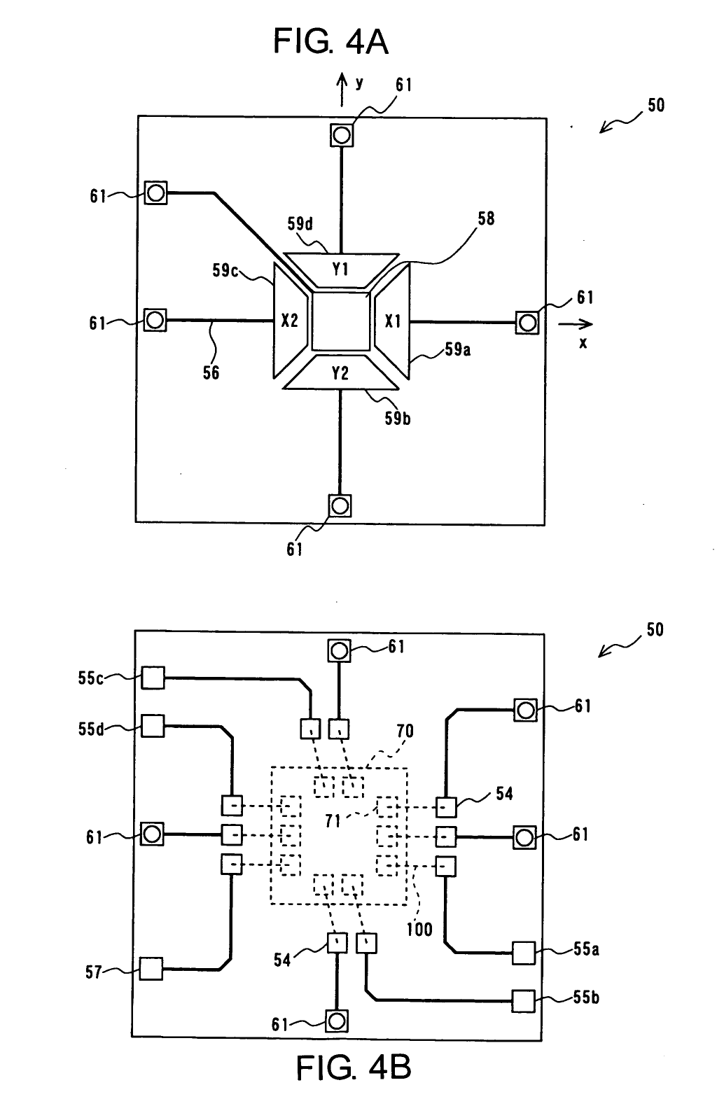

FIG. 4A is a plan view of a flexible substrate 50 of the angular velocity sensor shown in FIG. 3 seen from above (fixed electrode side), and FIG. 4B is a plan view of the flexible substrate 50 seen from below.

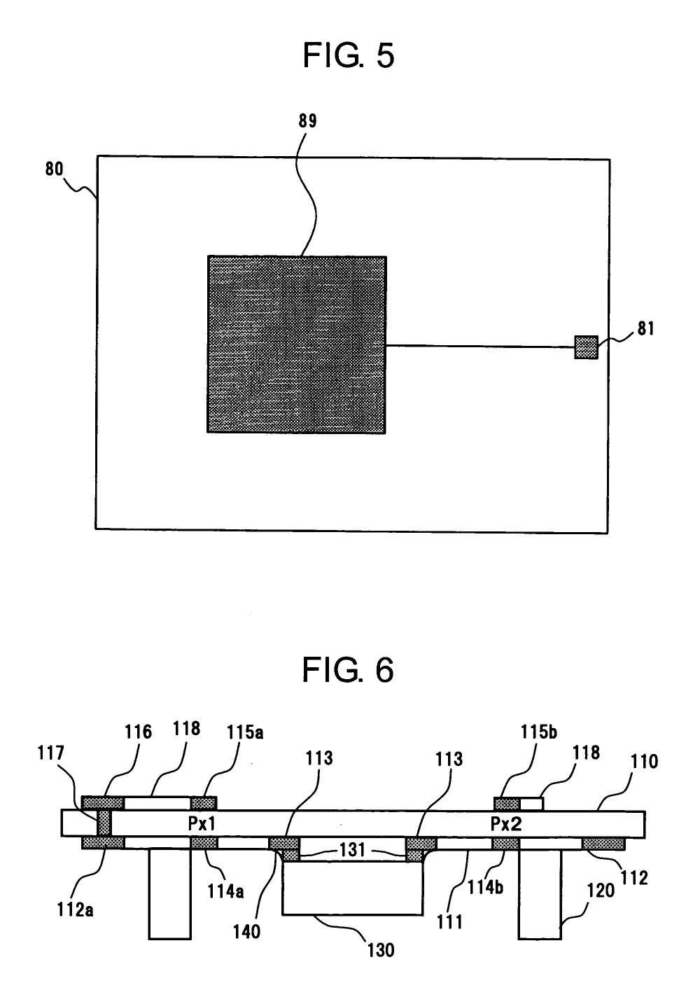

Also, FIG. 5 is a plan view of a fixed substrate of the angular velocity sensor according to the second embodiment seen from below.

As shown in FIG. 3, the angular velocity sensor is provided with the flexible substrate 50, a frame 60, a mass part 70 and a fixed substrate 80.

The flexible substrate 50 is formed by a core part 51 configured by a metal spring material such as SUS (stainless steel), and an insulating film 52 provided to cover the surface of the core part 51.

Note that the flexible substrate 50 may be configured by a silicon substrate, etc. as long as it has a configuration having sufficient flexibility.

The frame 60 is a fixed part configured by a hollow prismatic member provided at the periphery to surround the mass part 70 and configures the frame of the angular velocity sensor.

The mass part 70 is a mass body fixed at the center of the flexible substrate 50 by a joint member 53 such as adhesive. The mass part 70 can oscillate and twist with the force from the outside, with the action of the flexible substrate 50.

The mass part 70 is formed by an IC chip with the formation of the signal processing circuit for processing electrically the detection signal detected by the detecting element.

Plural IC electrode pads 71 for wiring are provided on the surface of the IC chip configuring the mass part 70 as shown in FIG. 4B.

Also, plural wire pads 54 are provided on the flexible substrate 50 and the IC electrode pad 71 and the wire pad 54 are electrically connected by using W/B (wire/bonding).

It should be noted that a wire 100 for connecting the IC electrode pad 71 and the wire pad 54 is wired with sufficient flexibility so as not to be cut when the posture of the mass part 70 changes.

As describe above, wiring the IC electrode pad 71 and the wire pad 54 makes it possible to input a detection signal to the IC chip configuring the mass part 70, that is, the signal processing circuit and to draw the processed signal from the signal processing circuit.

In addition, the flexible substrate 50 is provided with external discharge pads 55a-d near the outer edge thereof.

The external discharge pads 55a-d are also electrically connected to the wire pad 54 through a wiring pattern 56.

The external discharge pad 55a is a power input terminal for applying operating voltage of capacitive elements Cy1, Cy2, Cz1 and Cz2 as a detecting element described later and the signal processing circuit formed on the IC chip from the outside.

The external discharge pad 55b is connected to a ground (GND) in the signal processing circuit formed on the IC chip. The external discharge pad 55b is connected to a frame ground (FG) in the angular velocity sensor.

The external discharge pad 55c is an output terminal of the x-axis direction component of the external force acting on the mass part 70, that is, the x-axis direction component of angular velocity output as a processing result in the signal processing circuit formed on the IC chip.

The external discharge pad 55d is an output terminal of the y-axis direction component of the external force acting on the mass part 70, that is, the y-axis direction component of angular velocity output as a processing result in the signal processing circuit formed on the IC chip.

The angular velocity sensor according to the second embodiment is provided with a posture detecting means for detecting the posture state of the mass part 70.

The detection of the posture state of the mass part 70 is carried out by detecting the capacitance between the electrodes provided at the flexible substrate 50 for supporting the mass part 70 and at the fixed substrate 80 fixed at the flexible substrate 50 through a spacer 90. The capacitive element (capacitor) is configured by the fixed electrode and the movable electrode which are provided on the opposed surface of the fixed substrate 80 and the flexible substrate 50, and the posture state of the mass part 70 is detected by detecting the capacitance of this capacitor.

It should be noted that the fixed electrode and the movable electrode for detecting the posture state of the mass part 70 are defined as electrode for detection.

In the angular velocity sensor according to the second embodiment, the posture of the mass part 70 is detected by detecting the inclination in the x-axis direction and the y-axis direction. In other words, the posture of the mass part 70 is detected by detecting the slope components in two-axis directions respectively.

As shown in FIG. 4A, the x-axis direction component is detected from the posture state (inclination state) of the mass part 70 at the positions of X1 and X2 by setting the central axis of the mass part 70 as a reference. Similarly, the y-axis direction component is detected from the posture state (inclination state) of the mass part 70 at the positions of Y1 and Y2.

In more detail, as shown in FIG. 4A, four movable electrodes 59a-59d for detection are provided on the surface opposing to the fixed substrate 80 of the flexible substrate 50.

In addition, as shown in FIG. 3, a fixed electrode 89 is provided on the surface opposing to the flexible substrate 50 of the fixed substrate 80. The fixed electrode 89 is provided at the position contraposing the movable electrodes 59a-59d for detection.

The fixed electrode 89 is a common electrode for the movable electrodes 59a-59d for detection and a movable electrode 58 for driving described later and normally connected to the ground. The fixed electrode may be provided individually for the movable electrodes 59a-59d for detection and the movable electrode 58 for driving. In this case, the wiring for connecting each fixed electrode and the signal processing circuit (IC chip) is required. Consequently, the circuit configuration can be simplified with the common electrode.

Then the capacitive element Cx1 for detection is configured by the fixed electrodes 89 and the movable electrode 59a for detection. Similarly, the capacitive element Cy1 for detection is configured by the fixed electrode 89 and the movable electrode 59d for detection, the capacitive element Cx2 for detection is configured by the fixed electrode 89 and the movable electrode 59c for detection and the capacitive element Cy2 for detection is configured by the fixed electrode 89 and the movable electrode 59b for detection.

The x-axis direction component of the posture state of the mass part 70 is detected based on the capacitances of the capacitive elements Cx1 and Cx2 for detection while the y-axis direction component of the posture state of the mass part 70 is detected based on the capacitances of the capacitive elements Cy1 and Cy2 for detection.

In the second embodiment, the fixed electrode 89 is formed to face the whole surfaces of the movable electrodes 59a-59d for detection.

As shown in FIG. 4A, the movable electrodes 59a-59d for detection have the shape of trapezoid and are arranged to be at right angles to the adjacent electrode surrounding the movable electrode 58 for driving described later so that the shorter side of the sides parallel to each other in each electrode can face toward the center of the flexible substrate 50 (implementation position of the mass part 70).

The electrodes opposing on the same plane, that is, the electrodes located at the opposite sides sandwiching the center make a pair and detect each axis direction component of the posture state of the mass part 70.

The movable electrodes 59a-59d are electrically connected to the IC chip forming the mass part 70 implemented at the opposite side of the flexible substrate 50 through a via hole 61 and the wiring pattern 56. In addition, the fixed electrode 89 and the IC chip (signal processing circuit) are electrically connected by connecting a fixed electrode pad 81 on the fixed substrate and a fixed electrode discharge pad 57 on the flexible substrate 50 by W/B.

And there is configured so that various signals can be applied to the electrode through these leading wirings.

It should be noted that the capacitance between the electrodes can be electrically detected by using capacitance/voltage conversion (C/V conversion) circuit.

As the C/V conversion circuit, there is a method of detecting the amount of change of oscillation of the output signal as the capacitance by applying a carrier signal (reference signal) with sufficient high frequency to the capacitive element.

The oscillation of the output of the carrier signal applied to the capacitive element is proportional to the capacitance. For this reason, comparison between the oscillations of an input carrier signal and an output carrier signal makes it possible to detect the capacitance.

In the angular velocity sensor according to the second embodiment, an alternate signal with its frequency band from several hundreds of kHz to several MHz is applied to the electrodes of the above-described capacitive elements Cx1, Cx2, Cy1 and Cy2 for detection as a carrier signal.

Also in the angular velocity sensor according to the second embodiment, a C/V conversion circuit for detecting the capacitance for the elements of the capacitive elements Cx1, Cx2, Cy1 and Cy2 is provided.

In the angular velocity sensor according to the second embodiment, there is used a method of detecting the angular velocity acted on the periphery of the mass part 70 by oscillating the mass part 70 vertically (z-axis direction) and by generating Coriolis force on the mass part 70 making oscillatory movement.

The angular velocity sensor according to the second embodiment is provided with a driving means for oscillating the mass part 70 vertically.

The oscillation driving of the mass part 70 is performed, as shown in FIG. 4A, by applying a control signal for driving between the movable electrode 58 for driving provided at the center of the flexible substrate 50 (center of the implementation position of the mass part 70) and the fixed electrode 89 provided opposite to the movable electrode 58 for driving on the fixed electrode 80. This control signal for driving is assumed as, for example, an alternate signal with resonant frequency (several kHz or so) of the flexible part configured by the mass part 70 and the flexible substrate 50.

When the control signal is applied between the fixed electrode 89 and the movable electrode 58 for driving, that is, between the electrodes for driving, electrostatic force acts on between the electrodes. This action of the electrostatic force oscillates the mass part 70. Electrostatic force indicates attraction and repulsion caused by electric charge. Changing the control signal for driving applied to between the electrodes makes it possible to adjust the electrostatic force acting on between the electrodes.

The movable electrode 58 for driving is electrically connected to the IC chip forming the mass part 70 implemented on the opposite side of the flexible substrate 50 through the via hole 61 and the wiring pattern 56.

And there is configured so that the control signal for driving can be applied to the electrode through these leading wirings.

In addition, the arrangement gap between the flexible substrate 50 and the fixed substrate 80, that is, the distance between each fixed electrode and the movable electrode can be changed by adjusting the height of the spacer 90.

Next, the detection operation of the angular velocity sensor with such a configuration will be described.

In the angular velocity sensor, an alternating voltage is applied to between the movable electrode 58 for driving and the fixed electrode 89 to oscillate the mass part 70 vertically (z-axis direction) by the electrostatic force acting on between the electrodes.

The frequency of the alternating voltage applied for oscillating the mass part 70, that is, oscillation frequency of the mass part 70 is set at a resonant frequency f at 3 kHz or so at which the mass art 70 makes resonant oscillation.

As described above, oscillation of the mass part 70 at the resonant frequency f makes it possible to obtain a large amount of displacement of the mass part 70.

With an addition of an angular velocity Ω around the mass part 70 with a mass m oscillating at a velocity v, a Coriolis force of “F=2 mvΩ” is generated at the center of the mass part 70 in a direction orthogonal to the movement direction of the mass part 70.

With the generation of this Coriolis force F, twisting is added to the mass part 70 to change the posture of the mass part 70. In other words, the mass part 70 inclines to the plane orthogonal to the movement direction of the oscillation of the mass part 70. With the detection of the change of posture (inclination, amount of twisting) of the mass part 70, the direction and degree of the acting angular velocity is detected.

The change of posture of the mass part 70 is performed by detecting the change of the capacitances of the capacitive elements Cx1, Cx2, Cy1 and Cy2 as a detecting element.

With the detection of the change of the distance between the fixed electrode and the movable electrode, in other words, the change of posture of the mass part 70 is detected.

It should be noted that the capacitance between the electrodes can be electrically detected by using the capacitance/voltage conversion (C/V conversion) circuit. This C/V conversion circuit is one of signal processing circuits and provided in the IC chip configuring the mass part 70.

There is detected the Coriolis force F generated based on the change of posture (inclination direction, inclination degree, etc.) of the detected mass part 70.

Then the angular velocity Ω is calculated (derived) based on the detected Coriolis force F. In other words, the amount of change of posture of the mass part 70 is converted into the angular velocity.

In the angular velocity sensor according to the second embodiment, although the IC electrode pad 71 and the wire pad 54 are connected to each other by W/B (wire bonding), the method of fixing (connecting) the IC chip is not limited to this.

The IC chip may be fixed at (connected to) the flexible substrate 50 by, for example, soldering using FCB used in the first embodiment.

When the IC chip is electrically connected to the flexible substrate 50 by soldering using FCB, connection can be achieved by shorter wiring than the case of using W/B and the influence of disturbance noise received through the wiring connecting the detecting element and the signal processing circuit can be further reduced.

In the case of using soldering by FCB, in addition, since the pad on the IC chip and the pad on the flexible substrate 50 can be directly joined, the sensor structure can be downsized more than the case of using W/B.

Note that, in FCB, Au (gold) bump, solder bump, etc. are used. Although there are various forming methods, in the case of using Au bump, a stud bump type (the end of ball-shaped Au wire rod is cut) and a plated bump type (formed by electrolytic plating, nonelectrolytic plating) are used. As the type of joint, for example, there are Au—Sn (gold-tin), Au—Au (gold-gold), ACF (anisotropic conductive connection film/with conductive particle), NCP (anisotropic conductive connection paste/without conductive particle), Ag (silver) paste, soldering, etc.

In the case of using W/B for the connection between the IC chip and the flexible substrate 50, on the other hand, since the effect of thermal stress can be limited, deformation such as warpage and distortion of the flexible substrate 50 can be prevented.

According to the second embodiment, provision of the signal processing circuit, i.e., IC chip near the capacitive elements Cx1, Cx2, Cy1 and Cy2 as a displacement detecting means (detecting element) of the mass part 70 can make the wiring connecting the detecting element and the signal processing circuit short.

Thereby the influence of disturbance noise received through the wiring connecting the detecting element and the signal processing circuit can be reduced to improve the sensor sensitivity and accuracy.

Also, configuration of the mass part 70 by the IC chip with the signal processing circuit formed can downsize the angular velocity without a great change of the shape of the mass part 70.

In the sensor part, as described above, since there can be configured without changing the shape of the mass part 70, that is, without reducing the mass of the movable part, the sensor sensitivity and accuracy do not occur with the downsizing.

Also in the acceleration sensor according to the first embodiment, there may be provided a driving means for oscillating the mass part 30 in the z-axis direction similarly to the angular velocity sensor according to the second embodiment to function as the angular velocity sensor.

There is configured to oscillate the mass part 30 in the z-axis direction by the driving means and to detect the inclination of the mass part 30 to the plane orthogonal to the oscillation direction based on the amount of deformation of the flexible substrate 10.

More specifically, based on the change of the resistance value in the piezoresistances Rx1, Rx2, Ry1, Ry2, Rz1 and Rz2 provided at the flexible substrate 10, the Coriolis force acting on the mass part 30 is detected. Then the angular velocity is calculated (derived) based on the detected Coriolis force F. In other words, the amount of change of posture of the mass part 30 is converted into the angular velocity.

Also in the acceleration sensor according to the first embodiment, the same detecting element as in the angular velocity sensor according to the second embodiment may be used.

More specifically, the fixed substrate provided with the fixed electrode for detection through a predetermined gap (space) is provided on the flexible substrate 10, and further the movable electrode for detection is provided on the flexible substrate 10 instead of providing the piezoresistances Rx1, Rx2, Ry1, Ry2, Rz1 and Rz2. Then the change of posture of the mass part 30 is detected based on the amount of change of capacitance between the fixed electrode for detection and the movable electrode for detection.

In the first and second embodiments described above, although there is configured so that the signal processing circuit is formed on the IC chip to function the IC chip as the mass part, the method of forming (embedding) the signal processing circuit on the movable part is not limited to this. For example, the signal processing circuit may be formed directly on the flexible substrate.

Also in the case of forming the signal processing circuit on the flexible substrate as described above, the connection wiring between the detecting element and the signal processing circuit can be formed to be shorter than in the case of forming the signal processing circuit at a fixed position of the sensor. For this reason, resistance to an exogenous noise can be improved more.

In addition, as the first and second embodiments described above, formation of the signal processing circuit to be IC chip can prevent a semiconductor process, i.e., the manufacturing process of the mechanical quantity sensor from being complicated (complex) and reduce the manufacturing cost.

### Third Embodiment

Next, as the preferred third embodiment of the invention, there will be described an acceleration sensor using a piezoelectric element as a detecting element.

FIG. 6 is a sectional view showing a schematic configuration of the acceleration sensor according to the third embodiment.

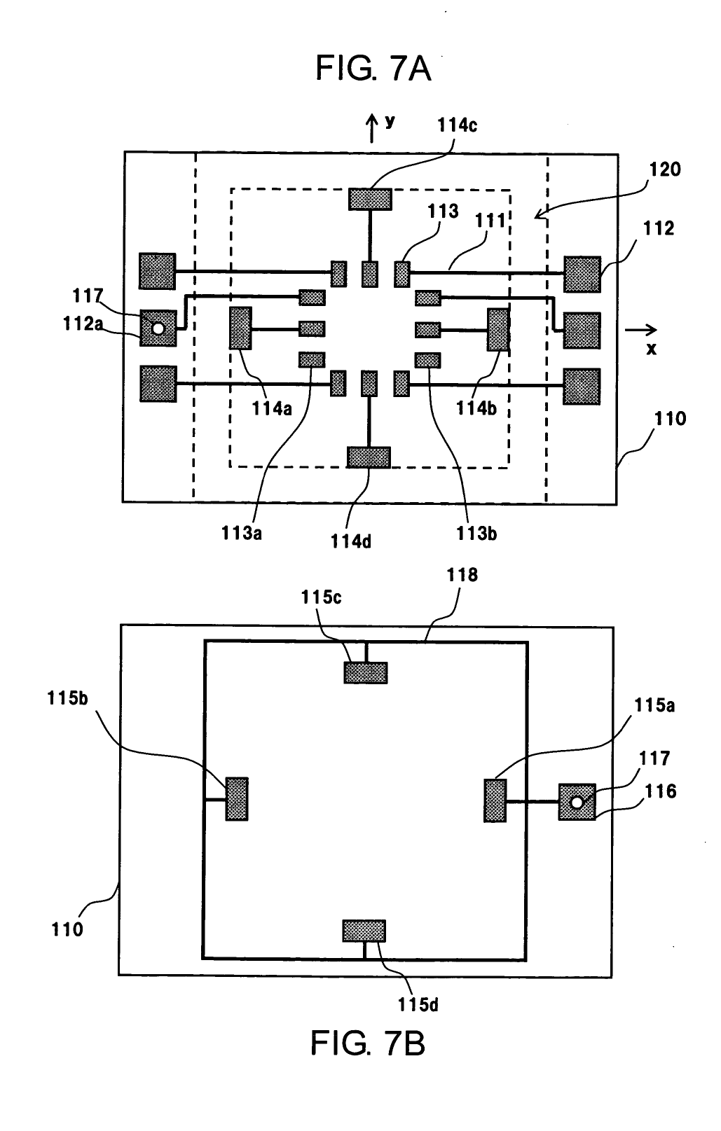

FIG. 7A is a plan view of a flexible substrate 110 of the acceleration sensor shown in FIG. 6 seen from below while FIG. 7B is a plan view of the flexible substrate 110 seen from above.

As shown in FIG. 6, the acceleration sensor is provided with the flexible substrate 110, a frame 120 and a mass part 130.

The flexible substrate 110 is formed by a piezoelectric material such as lead zirconate titanate (PZT) and barium titanate to have sufficient flexibility.

It should be noted, in this embodiment, that although the flexible substrate 110 has a simple flat plate shape, i.e., a diaphragm shape, it may have a beam-like shape as in the first embodiment.

The frame 120 is a fixed part configured by a hollow prismatic member provided at the periphery to surround the mass part 130 and configures the frame of the acceleration sensor. Although the frame 120 and the flexible substrate 110 may be formed separately and bonded, they can be formed integrally.

The mass part 130 is a mass body fixed at the frame 120 through the flexible substrate 110. The mass part 130 can oscillate and twist with the force from the outside, with the action of the flexible substrate 110.

The mass part 130 is formed by an IC chip with the formation of the signal processing circuit for processing electrically the detection signal detected by the detecting element.

In this embodiment, the part between the IC chip configuring the mass part 130 and the flexible substrate 110, that is, a mass joint 140 can be fixed by soldering plural IC connection pads 113 formed on the flexible substrate 110 and a pad 131 provided on the IC chip side by using FCB (flip chip bonding), etc. In this case, however, in order to prevent deterioration (or destruction) of piezoelectric performance of the flexible substrate 110 due to an intense heat, it is preferable to use a low-melting solder. Or, a conductive adhesive (Ag paste, etc.) may be used for bonding.

On the IC chip, as in the first embodiment, dummy pads 113a, 113b for keeping the mass balance of the mass part 130 other than the pad 113 for conducting electrically.

On the undersurface of the flexible substrate 110, as shown in FIG. 7A, undersurface detecting electrodes 114a-d are formed between the frame 120 and the mass part 130, that is, at the position where the mass part 130 deforms (deflects) with the change of posture thereof with a force from the outside, and are connected to the IC connection pad 113 by the wiring pattern 111. Further, on the uppersurface of the flexible substrate 110, uppersurface detecting electrodes 115a-d are formed respectively at the position facing the undersurface detecting electrodes 114a-d. It should be noted that all of these uppersurface detecting electrodes 115a-d are connected to be common electrodes by the wiring pattern 118. Further, the electrical connection between the wiring 118 and the IC chip is performed through an undersurface pad 112a and an uppersurface pad 116 each with a via hole 117 formed.

Other than those above, on the undersurface of the flexible substrate 110, an external discharge pad 112 is also formed for power connection to the outside and for discharging an acceleration signal.

The area sandwiched between the undersurface detecting electrode 114a and the uppersurface detecting electrode 115a of the flexible substrate 110 functions as a piezoelectric element Px1. Similarly, a piezoelectric element Px2 is formed by the undersurface detecting electrode 114b and the uppersurface detecting electrode 115b, a piezoelectric element Py1 is formed by the undersurface detecting electrode 114c and the uppersurface detecting electrode 115c, and a piezoelectric element Py2 is formed by the undersurface detecting electrode 114d and the uppersurface detecting electrode 115d, respectively. The piezoelectric elements Px1 and Px2 are arranged in an x-axis direction across the mass part 130 while similarly the piezoelectric elements Py1 and Py2 are arranged in a y-axis.

These piezoelectric elements can detect the stress (or amount of deformation) acting on the element as a voltage (or electric charge) output between the electrodes with a function called piezoelectric effect.

In this embodiment, for example, when the mass part 130 inclines to the x-axis direction with the action of external force generated by acceleration, the flexible substrate 110 deforms and an inverse stress acts on the piezoelectric elements Px1 and Px2. In this case, when there is polarized in advance so that the piezoelectric effect can be obtained in the x-axis direction, the voltage generated from each piezoelectric element changes in an inverse direction. Accordingly, the acceleration acted in the x-axis direction can be obtained by detecting the difference. Also, the acceleration in the y-axis direction can be detected from the piezoelectric elements Py1 and Py2.

In addition, when the acceleration is acted in the z-axis direction, the mass part 130 is displaced keeping horizontal situation in a vertical direction. In this case, the piezoelectric elements Px1, Px2, Py1 and Py2 extend (is compressed) in the same direction. In this case, the acceleration in the z-axis direction can be detected not by calculating the difference of the voltage but by adding. In other words, using the piezoelectric elements arranged in the x-axis and y-axis directions makes it possible to detect the acceleration in the z-direction as well.

In addition, as in the first embodiment, the piezoelectric element (electrode pair) for detecting the acceleration in the z-axis direction can be formed.

It should be noted that the configuration of the piezoelectric element is not limited to this as shown in the third embodiment. For example, the sensitivity can be improved further by increasing the area of the piezoelectric element or by increasing the number per axis. Or, instead of using a piezoelectric material as the flexible substrate 110, a separate piezoelectric element may be formed (or firmly fixed) at the position as shown in the third embodiment.

Also, provision of a driving mechanism makes it possible to configure as an angular velocity sensor.

In more detail, provision of an electrode for driving on the uppersurface of the flexible substrate 110 and provision of a fixed electrode on the opposite surface (uppersurface of the flexible substrate) as in the second embodiment enable driving by electrostatic force.

Or, since the piezoelectric element can be elongated and contracted by applying a voltage (inverse piezoelectric effect), application of the same potential to the piezoelectric elements Px1, Px2, Py1 and Py2 respectively, for example, makes it possible to drive in the z-axis direction as well. In this case, it becomes necessary to provide another piezoelectric element for detection.

As described above, although the piezoelectric element is used in the third embodiment, a large-scale apparatus is required so as to form the piezoelectric resistance in the case of using the piezoelectric resistance as in the first embodiment while it suffices if an electrode is arranged on a piezoelectric substrate to reduce capital investment in the third embodiment. Also in the second embodiment, higher detection sensitivity can be obtained in the case of piezoelectric element than in the case of capacitance detection generally in many cases, which is advantageous.

What is claimed is:

1. A mechanical quantity sensor comprising:
a frame;
a movable part including a flexible part fixed at the frame and a mass part which is supported by the flexible part and whose posture changes with an action of an external force;
a detecting element at least a part of which is provided at the movable part;
a detecting means provided at the movable part and for detecting the change of posture of the mass part based on a change of a circuit constant of the detecting element; and
a converting means for converting the change of posture of the mass part detected by the detecting means into a mechanical quantity.

2. A mechanical quantity sensor according to claim 1, wherein the detecting means is formed at the mass part.

3. A mechanical quantity sensor according to claim 1, wherein the detecting element includes a piezoresistive element provided at the flexible part.

4. A mechanical quantity sensor according to claim 2, wherein the detecting element includes a piezoresistive element provided at the flexible part.

5. A mechanical quantity sensor according to claim 1, wherein the detecting element includes a capacitive element in which an electrode on one side is provided at the movable part.

6. A mechanical quantity sensor according to claim 2, wherein the detecting element includes a capacitive element in which an electrode on one side is provided at the movable part.

7. A mechanical quantity sensor according to claim 1, wherein the detecting element includes a piezoelectric element provided at the flexible part.

8. A mechanical quantity sensor according to claim 2, wherein the detecting element includes a piezoelectric element provided at the flexible part.

9. A mechanical quantity sensor according to claim 1, wherein the mass part includes a semiconductor chip with at least the detecting means formed.

10. A mechanical quantity sensor according to claim 2, wherein the mass part includes a semiconductor chip with at least the detecting means formed.

11. A mechanical quantity sensor according to claim 3, wherein the mass part includes a semiconductor chip with at least the detecting means formed.

12. A mechanical quantity sensor according to claim 4, wherein the mass part includes a semiconductor chip with at least the detecting means formed.

13. A mechanical quantity sensor according to claim 5, wherein the mass part includes a semiconductor chip with at least the detecting means formed.

14. A mechanical quantity sensor according to claim 6, wherein the mass part includes a semiconductor chip with at least the detecting means formed.

15. A mechanical quantity sensor according to claim 7, wherein the mass part includes a semiconductor chip with at least the detecting means formed.

16. A mechanical quantity sensor according to claim 8, wherein the mass part includes a semiconductor chip with at least the detecting means formed.

17. A mechanical quantity sensor according to claim 9, wherein the semiconductor chip and the flexible part are provided with a fixed pad pairing each other and are bonded to each other by flip chip bonding or wire bonding through the fixed pad.

18. A mechanical quantity sensor according to claim 10, wherein the semiconductor chip and the flexible part are provided with a fixed pad pairing each other and are bonded to each other by flip chip bonding or wire bonding through the fixed pad.

19. A mechanical quantity sensor according to claim 17, wherein the fixed pad is provided at a position where a mass is distributed so as to keep a mass balance of the mass part.

20. A mechanical quantity sensor according to claim 18, wherein the fixed pad is provided at a position where a mass is distributed so as to keep a mass balance of the mass part.
